(19) United States
(12) Patent Application Publication
(10) Pub. No.: US 2005/0021732 A1
(43) Pub. Date: Jan. 27, 2005

(54) Method and system for routing traffic in a server system and a computer system utilizing the same

(75) Inventors: Edward S. Suffern, Chapel Hill, NC (US); Joseph E. Bolan, Morrissville, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/610,095

(22) Filed: Jun. 30, 2003

(51) Int. Cl. G06F 15/173

(52) U.S. Cl. 709/224; 709/225

(57) ABSTRACT

A method for routing traffic in a server system and a computer system utilizing the same is disclosed. In a first aspect, the method comprises sensing a first condition in a server of a plurality of servers and adjusting traffic to the server in response to the first condition. In a second aspect, a computer system comprises a plurality of servers, wherein each of the plurality of servers comprising a monitoring mechanism for sensing a first condition in a server, a plurality of switch modules coupled to the plurality of servers, a management module, and a traffic control mechanism coupled to the management module, wherein the traffic control mechanism causes each of the plurality of switch modules to adjust traffic to the server when the first condition is sensed in the server.

### FIELD OF THE INVENTION

The present invention relates generally to computer server systems and, more particularly, to a method and system for routing traffic in a server system.

### BACKGROUND OF THE INVENTION

In today's environment, a computing system often includes several components, such as servers, hard drives, and other peripheral devices. These components are generally stored in racks. For a large company, the storage racks can number in the hundreds and occupy huge amounts of floor space. Also, because the components are generally free standing components, i.e., they are not integrated. Resources such as floppy drives, keyboards and monitors, cannot be shared.

A system has been developed by International Business Machines Corp. of Armonk, N.Y., that bundles the computing system described above into a compact operational unit. The system is known as an IBM eServer BladeCenter.™ The BladeCenter is a 7U modular chassis that is capable of housing up to 14 individual server blades. A server blade or blade is a computer component that provides the processor, memory, hard disk storage and firmware of an industry standard server. Each blade is “hot-plugged” into a slot in the chassis. The chassis also houses supporting resources such as power, switch, management and blower modules. Thus, the chassis allows the individual blades to share the supporting resources infrastructure.

For redundancy purposes, two Ethernet Switch Modules (ESMs) are mounted in the chassis. The ESMs provide Ethernet switching capabilities to the blade server system. The primary purpose of each switch module is to provide Ethernet interconnectivity between the server blades, the management modules, and the outside network infrastructure.

The ESMs are higher function ESMs, e.g., OSI Layer 4—Routing layer and above, that are capable of load balancing among different Ethernet ports connected to a plurality of server blades. Each ESM executes a standard load balancing algorithm for routing traffic among the plurality of server blades so that the load is distributed evenly across the blades. This load balancing algorithm is based on an industry standard Virtual Router Redundancy Protocol. This standard does not describe the implementation with the ESM. Such standard algorithms are specific to the implementation and may be based on round robin selection, least connections, or response time.

Nevertheless, problems arise when one of the plurality of server blades fails. Because the standard load balancing algorithms are oblivious to impending blade failure, traffic is routed to the failing server blade until the blade actually fails. In that case, the blade will immediately sever all existing connections. A user application must recognize the outage and re-establish each connection. For an individual user accessing the server system, this sequence of events is highly disruptive because the user will experience an outage of service of approximately 40 seconds. Cumulatively, the disruptive impact is multiplied several times if the failed blade was functioning at full capacity, i.e., carrying a full load, before failure.

Under normal operating conditions a server blade does not fail immediately. There is a degradation of service due to a variety of causes. In one case, the server blade requests, i.e., users, have exceeded the processing power of the server blade. Here, a virtual routing technique throttles the requests thereby limiting the number of new users. Accordingly, the degrading server blade can service its current users. Nevertheless, if a server blade experiences an environmental degradation such as high temperature or out of specification voltages, the current art of the server blade has no method to factor these conditions into the virtual routing algorithm.

Accordingly, a need exists for a system and method for routing traffic in a server system that is sensitive to degrading environmental problems in a server. The system and method should allow dynamic adjustment of the load balancing algorithm depending on the operational health of each server. The present invention addresses such a need.

### SUMMARY OF THE INVENTION

A method for routing traffic in a server system and a computer system utilizing the same is disclosed. In a first aspect, the method comprises sensing a first condition in a server of a plurality of servers and adjusting traffic to the server in response to the first condition. In a second aspect, a computer system comprises a plurality of servers, wherein each of the plurality of servers comprising a monitoring mechanism for sensing a first condition in a server, a plurality of switch modules coupled to the plurality of servers, a management module also coupled to the plurality of servers, and a traffic control mechanism coupled to the management module, wherein the traffic control mechanism causes each of the plurality of switch modules to adjust traffic to the server when the first condition is sensed in the server.

### BRIEF DESCRIPTION OF THE DRAWINGS

FIG. 1 is a perspective view illustrating the front portion of a BladeCenter.

FIG. 2 is a perspective view of the rear portion of the BladeCenter.

FIG. 3 is a schematic diagram of the server blade system's management subsystem.

FIG. 4 is a schematic block diagram of the server blade system according to a preferred embodiment of the present invention.

FIG. 5 is a flowchart illustrating a process by which the traffic control mechanism routes traffic according to a preferred embodiment of the present invention.

### DETAILED DESCRIPTION

The present invention relates generally to server systems and, more particularly, to a method and system for routing traffic in a server system. The following description is presented to enable one of ordinary skill in the art to make and use the invention and is provided in the context of a patent application and its requirements. Although the preferred embodiment of the present invention will be described in the context of a BladeCenter, various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

According to a preferred embodiment of the present invention, a traffic control mechanism, coupled to each of a plurality of servers, monitors each server for any sign of environmental degradation, e.g., out-of-specification temperature or voltage. When the traffic control mechanism senses a sign of degradation in a server, it causes additional traffic to the server to cease. To do this, the traffic control mechanism instructs each ESM to adjust its load balancing algorithm so that new connections to the server are not established while the degradation condition(s) exists. By restricting new traffic to the server when it shows signs of degradation, the number of connections that potentially may be severed if the server eventually fails is greatly reduced. Thus, the disruptive impact on the user community is minimized. Also, the health of the server may improve if no new connections are established, e.g., the power dissipation may be less and the environmental conditions may improve because of fewer connections.

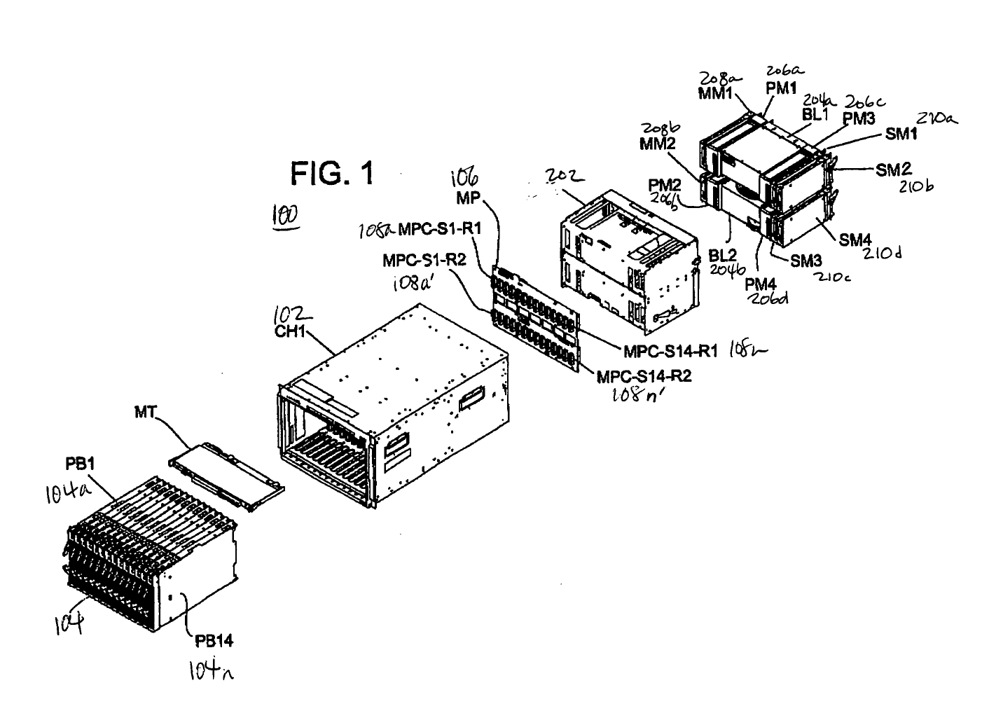

To describe the features of the present invention, please refer to the following discussion and Figures, which describe a computer system, such as the BladeCenter, that can be utilized with the present invention. FIG. 1 is an exploded perspective view of the BladeCenter system 100. Referring to this figure, a main chassis 102 houses all the components of the system. Up to 14 server blades 104 (or other blades, such as storage blades) are hot plugable into the 14 slots in the front of chassis 102. Blades 104 may be ‘hot swapped’ without affecting the operation of other blades 104 in the system 100. A server blade 104a can use any microprocessor technology so long as it is compliant with the mechanical and electrical interfaces, and the power and cooling requirements of the system 100.

A midplane circuit board 106 is positioned approximately in the middle of chassis 102 and includes two rows of connectors 108, 108′. Each one of the 14 slots includes one pair of midplane connectors, e.g., 108a, 108a′, located one above the other, and each pair of midplane connectors, e.g., 108a, 108a′ mates to a pair of connectors (not shown) at the rear edge of each server blade 104a.

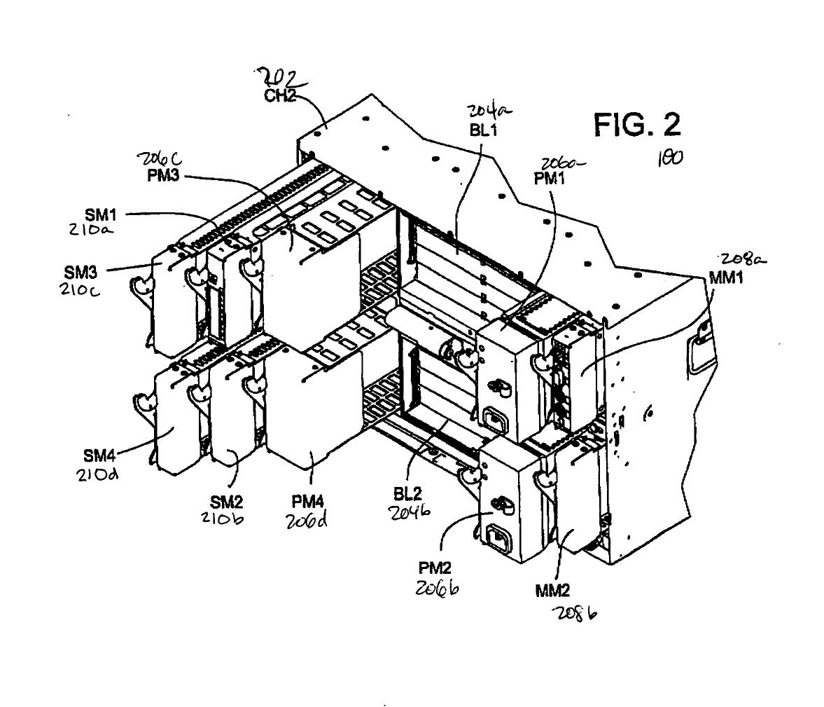

FIG. 2 is a perspective view of the rear portion of the BladeCenter system 100, whereby similar components are identified with similar reference numerals. Referring to FIGS. 1 and 2, a second chassis 202 also houses various hot plugable components for cooling, power, management and switching. The second chassis 202 slides and latches into the rear of main chassis 102. As is shown in FIGS. 1 and 2, two hot plugable blowers 204a, 204b provide cooling to the blade system components. Four hot plugable power modules 206 provide power for the server blades and other components. Management modules MM1 and MM2 (208a, 208b) are hot-plugable components that provide basic management functions such as controlling, monitoring, alerting, restarting and diagnostics. Management modules 208 also provide other functions required to manage shared resources, such as multiplexing a keyboard/video/mouse (KVM) (not shown) to provide a local console for the individual blade servers 104 and configuring the system 100 and switching modules 210.

The management modules 208 communicate with all of the key components of the system 100 including the switch 210, power 206, and blower 204 modules as well as the blade servers 104 themselves. The management modules 208 detect the presence, absence, and condition of each of these components. When two management modules are installed, a first module, e.g., MM1 (208a), assumes the active management role, while the second module MM2 (208b) serves as a standby module.

The second chassis 202 also houses up to four switching modules SM1 through SM4 (210a-210d). Each switch module includes several external data ports (not shown) for connection to the external network infrastructure. Each switch module 210 is also coupled to each one of the blades 104. The primary purpose of the switch module 210 is to provide interconnectivity between the server blades (104a-104n) and the outside network infrastructure. In addition a Local Area Network (LAN) connection to the management module exists for switch management purposes. Depending on the application, the external interfaces may be configured to meet a variety of requirements for bandwidth and function.

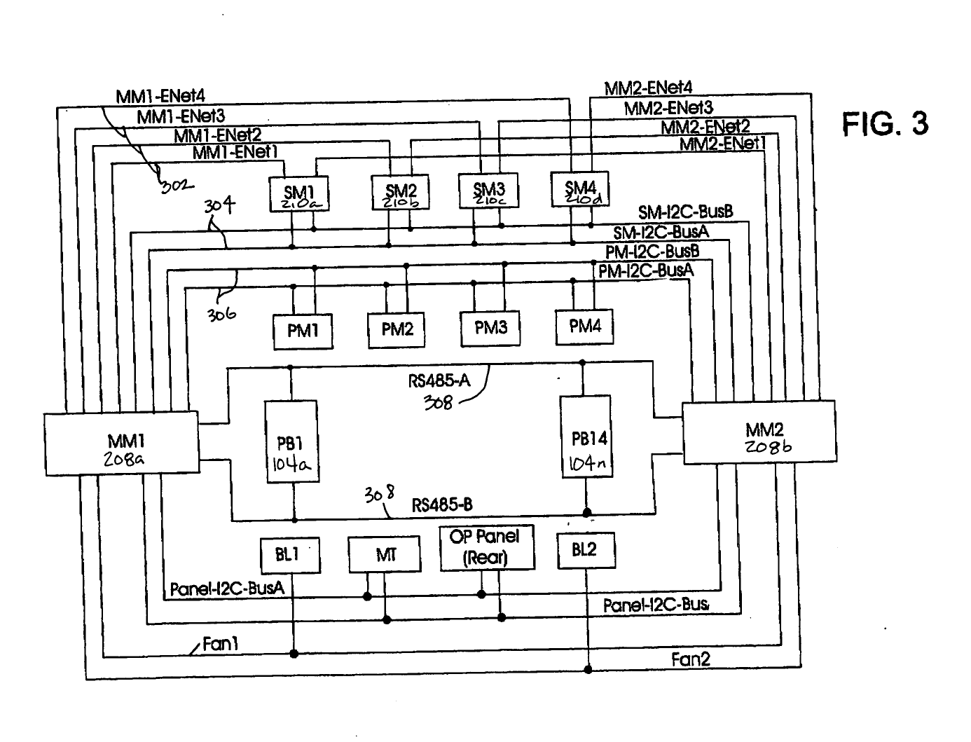

FIG. 3 is a schematic diagram of the server blade system's management subsystem 300, where like components share like identifying numerals. Referring to this figure, each management module (208a, 208b) has a separate Ethernet link 302 to each one of the switch modules (210a-210d). This provides a secure high-speed communication path to each of the switch modules (210) for control and management purposes only. In addition, the management modules (208a, 208b) are coupled to the switch modules (210a-210d) via two well known serial I²C buses (304), which provide for “out-of-band” communication between the management modules (208a, 208b) and the switch modules (210a-210d). The I²C serial buses 304 are used by the management module (208) to internally provide control of the switch module (210), i.e., configuring parameters in each of the switch modules (210a-210d). The management modules (208a, 208b) are also coupled to the server blades (104a-104n) via two serial buses (308) for “out-of-band” communication between the management modules (208a, 208b) and the server blades (104a-104n).

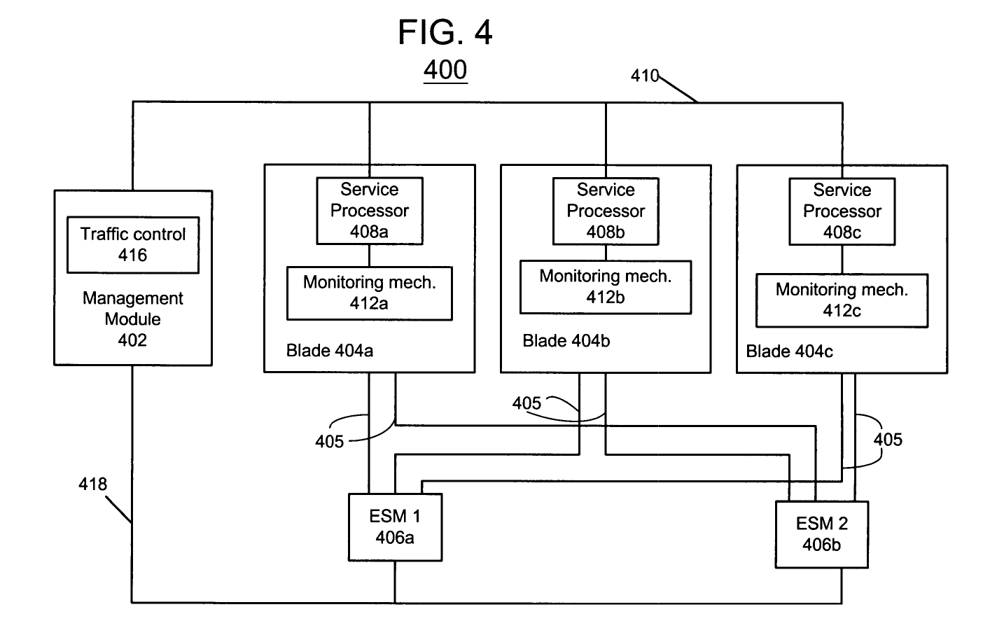

FIG. 4 is a schematic block diagram of a server system 400 according to a preferred embodiment of the present invention. For the sake of clarity, FIG. 4 depicts one management module 402, three blades 404a-404c, and two ESMs 406a, 406b. Nevertheless, it should be understood that the principles described below could apply to more than one management module, to more than three blades, and to more than two ESMs.

Each blade 404a-404c includes several internal ports 405 that couple it to each one of the ESMs 406a, 406b. Thus, each blade 404a-404c has access to each one of the ESMs 406a, 406b. The ESMs 406a, 406b perform load balancing of Ethernet traffic to each of the server blades 404a-404c. At any given time, each server blade 404a-404c maintains a plurality of Ethernet connections, each representing a session with a user. If a blade server, e.g., 404a, fails for any reason, all of the connections are severed and must be re-established/rerouted to other server blades 404b, 404c. This process can take approximately 40 seconds, which causes significant disruptions in service to the affected users.

The present invention addresses this problem. Each blade 404a-404c includes a monitoring mechanism 412a-412c, which monitors environmental conditions in the blade 404a-404c, such as blade temperature, voltage, and memory errors. In a preferred embodiment of the present invention, the monitoring mechanism 412a-412c sets threshold values based on different environmental conditions. The threshold values represent an acceptable operating environment. If any environmental condition is above (or below) the associated threshold value, the monitoring mechanism 412a-412c detects this condition and transmits a warning to the management module 402. Thus, via the monitoring mechanisms 412a-412c, the system 400 detects signs of potential blade degradation and can take corrective actions before the server blade 404a-404c reaches catastrophic failure.

In the preferred embodiment of the present invention, a traffic control mechanism 416 is coupled to each of the blades 404a-404c and to each ESM 406a, 406b. In one embodiment, the traffic control mechanism 416 is in the management module 402 and therefore utilizes the “out-of-band” serial bus 410 to communicate with each of the blades 406a-404c through a dedicated service processor 408a-408c in each blade. In another embodiment, the traffic control mechanism 416 is a stand alone module coupled to the service processors 408a-408c and coupled to the ESMs 406a, 406b.

The traffic control mechanism 416 preferably communicates with the ESM to oversee the traffic flow between the blades 404a-404c and switch modules 406a, 406b. The traffic control mechanism 416 also communicates with each service processor 408a-408c to determine the environmental health of each server blade 404a-404c. If a server blade (e.g., 404a) shows signs of degrading as communicated by the service processor 408a over the “out of band” serial bus 410, the traffic control mechanism 416 transmits a message to each of the ESMs 406a, 406b, via the connection 418, instructing them to stop establishing new connections to the degrading server blade 404a until the degrading server blade 404a recovers. By restricting new connections to the degrading server blade 404a in this manner, the degrading server blade 404a is given a chance to recover if its degraded environmental condition is load based. In the event the degrading server blade 404a fails, adverse impact on the users is minimized.

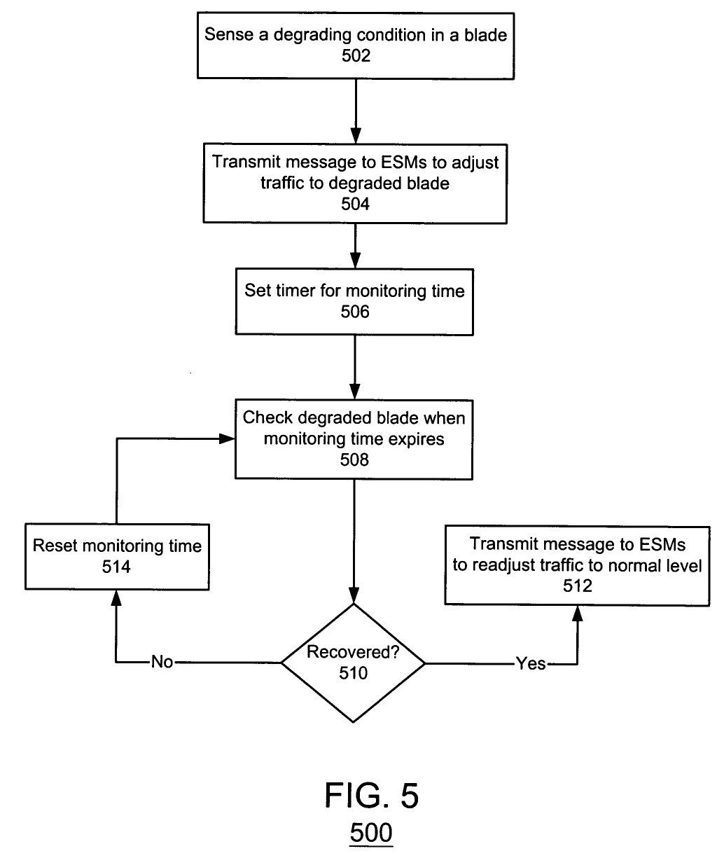

FIG. 5 is a flowchart illustrating a process by which the traffic control mechanism 416 routes traffic according to a preferred embodiment of the present invention. The process 500 starts at step 502, when the monitoring mechanism, e.g., 512a, senses a degrading environmental condition in a server blade 404a. The degrading condition can be any indication of potential failure, including, but not limited, to a high temperature or voltage measurement, an excessive number of memory errors, or PCI/PCIX parallel bus errors. All of these conditions are noted by the service processor 408a after being detected by the monitoring mechanism 412a in the server blade 404a. The monitoring mechanism 412a transmits a warning to the traffic control mechanism 416 preferably via the service processor 408a and bus 410.

In step 504, the traffic control mechanism 416 transmits a message to each ESM 406a, 406b instructing them to adjust traffic to the degraded server blade 404a. In a preferred embodiment, each ESM 406a, 406b adjusts the load distribution by removing, i.e., excluding, the degraded server blade 404a from the load balancing algorithm. As a result, no new connections are established for the degraded blade 404a. In another embodiment, the number of new connections to the degraded server blade 404a are reduced and not entirely eliminated. In either case, existing connections to the degraded blade 404a are unaffected.

Next, or simultaneously, the traffic control mechanism 416 sets a timer for a monitoring time in step 506. The monitoring time is a time period after which the traffic control mechanism seeks an update from the monitoring mechanism 412a in the degraded server blade 404a. The monitoring time is generally in a range of a few minutes to avoid over reacting and to smooth out the transitions between degraded and non-degraded states. During the monitoring time, the condition of the degraded server blade 404a may stabilize due to the reduced traffic. For example, the degraded blade's condition may have been caused by a peak in traffic that resulted in a corresponding high dissipation in power causing a temperature spike. By reducing the traffic to the degraded blade 404a, the condition may stabilize and return to normal.

In step 508, the traffic control mechanism 416 checks the condition of the degraded blade 404a after the monitoring time expires. If the degraded blade 404a has recovered, i.e. the blade 404a is operating within the threshold values, the traffic control mechanism 416 transmits a message to each ESM 406a, 406b to readjust the traffic to the recovered server blade 404a to its normal levels in step 512. In a preferred embodiment, each ESM 406a, 406b includes the recovered server blade 404a back into the load balancing algorithm so that new connections are established. If the degraded blade 404a has not recovered (as determined in step 510), i.e., the degrading condition in the blade 404a persists or has worsened, the traffic control mechanism 416 resets the timer in step 514 and repeats steps 508 and 510.

Eventually, if the situation does not improve, a system administrator will be alerted and the degraded server blade 404a shut down. At this point, however, a minimum number of connections are severed because new connections have been restricted. Thus, the adverse impact of shutting down the server blade 404a is minimized.

While the preferred embodiment of the present invention has been described in the context of a BladeCenter environment, the functionality of the load balancing mechanism 416 could be implemented in any computer environment where the servers are closely coupled. Thus, although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for routing traffic in a server system, the server system including a plurality of servers, the method comprising the steps of:
a) sensing a first condition in a server of the plurality of servers; and
b) adjusting traffic to the server in response to the first condition.

2. The method of claim 1, wherein the plurality of servers are coupled to a plurality of switch modules.

3. The method of claim 2, wherein the adjusting step (b) further comprising the step of:
(b1) transmitting a message to each of the plurality of switch modules; and
(b2) excluding the server from a load balancing algorithm in each of the plurality of switch modules in response to the message so that no new connections to the server are established.

4. The method of claim 3, wherein the adjusting step (b) further comprising:
(b3) maintaining existing connections to the server.

5. The method of claim 1 further comprising:
c) setting a timer for a monitoring time.

6. The method of claim 5, wherein the first condition is a degrading environmental condition in the server caused by one of an excess temperature or voltage, an excessive number of memory errors, or PCI/PCIX parallel bus errors.

7. The method of claim 6 further comprising the steps of:
d) checking the degrading environmental condition in the server after the monitoring time expires; and
e) readjusting the traffic to the server if the server recovers.

8. The method of claim 7, wherein the readjusting step (e) comprising:
(e1) transmitting another message to each of the plurality of switch modules; and
(e2) including the server back into the load balancing algorithm in each of the plurality of switch modules in response to the another message so that the traffic to the server returns to its normal level.

9. The method of claim 7 further comprising:
f) resetting the timer if the server does not recover; and
g) repeating steps (d)-(f).

10. The method of claim 9 further comprising:
(h) transmitting an alarm to an administrator.

11. The method of claim 1, wherein the first condition is a non-critical environmental condition indicative of a potential server failure.

12. A computer readable medium containing program instructions for routing traffic in a server system, the server system including a plurality of servers, the instructions for:
a) sensing a first condition in a server of the plurality of servers; and
b) adjusting traffic to the server in response to the first condition.

13. The computer readable medium of claim 12, wherein the plurality of servers are coupled to a plurality of switch modules.

14. The computer readable medium of claim 13, wherein the adjusting instruction (b) further comprising the instructions for:
(b1) transmitting a message to each of the plurality of switch modules; and
(b2) excluding the server from a load balancing algorithm in each of the plurality of switch modules in response to the message so that no new connections to the server are established.

15. The computer readable medium of claim 14, wherein the adjusting instruction (b) further comprising:
(b3) maintaining existing connections to the server.

16. The computer readable medium of claim 12 further comprising:
c) setting a timer for a monitoring time.

17. The computer readable medium of claim 16, wherein the first condition is a degrading environmental condition in the server caused by one of an excess temperature or voltage, an excessive number of memory errors, or PCI/PCIX parallel bus errors.

18. The computer readable medium of claim 17 further comprising the instructions for:
d) checking the degrading environmental condition in the server after the monitoring time expires; and
e) readjusting traffic to the server if the server recovers.

19. The computer readable medium of claim 18, wherein the readjusting instruction (e) comprising:
(e1) transmitting another message to each of the plurality of switch modules; and
(e2) including the server back into the load balancing algorithm in each of the plurality of switch modules in response to the another message so that the traffic to the server returns to its normal level.

20. The computer readable medium of claim 18 further comprising:
f) resetting the timer if the server does not recover; and
g) repeating instructions (d)-(f).

21. The computer readable medium of claim 20 further comprising:
(h) transmitting an alarm to an administrator.

22. The computer readable medium of claim 12, wherein the first condition is a non-critical environmental condition indicative of a potential server failure.

23. A system for routing traffic in a server system, the server system including a plurality of servers, the system comprising:
a monitoring mechanism in each of the plurality of servers for sensing a first condition in a server;
a plurality of switch modules coupled to the plurality of servers; and
a traffic control mechanism coupled to each of the plurality of servers and to each of the plurality of switch modules, wherein the traffic control mechanism comprising means for causing each of the plurality of switch modules to adjust traffic to the server when the first condition is sensed in the server.

24. The system of claim 23, wherein the traffic control mechanism includes means for transmitting a message to each of the plurality of switch modules.

25. The system of claim 24, wherein each of the switch modules executes a load balancing algorithm and each of the switch modules includes means for excluding the server from the load balancing algorithm in response to the message so that no new connections to the server are established.

26. The system of claim 25, wherein each of the switch modules further includes means for maintaining existing connections to the server.

27. The system of claim 23, wherein the traffic control mechanism further includes a timing means for setting a monitoring time.

28. The system of claim 27, wherein the first condition is a degrading environmental condition in the server caused by one of an excess temperature or voltage, an excessive number of memory errors, or PCI/PCIX parallel bus errors.

29. The system of claim 28, wherein the traffic control mechanism further comprising:
means for checking the degrading environmental condition in the server after the monitoring time expires; and
means for causing each switch module to readjust traffic to the server if the server recovers.

30. The system of claim 29, wherein the traffic control mechanism further comprises:
means for transmitting another message to each of the plurality of switch modules.

31. The system of claim 30, wherein each switch module further comprising:
means for including the server back into the load balancing algorithm in response to the another message so that the traffic to the server returns to its normal level.

32. The system of claim 29, wherein the traffic control mechanism further comprising means for resetting the timer if the server does not recover.

33. The system of claim 32 further comprising:
means for transmitting an alarm to an administrator.

34. A computer system comprising:
a plurality of servers, wherein each of the plurality of servers comprising a monitoring mechanism for sensing a first condition in a server;
a plurality of switch modules coupled to the plurality of servers;
a management module coupled to each of the plurality of servers and to each of the plurality of switch modules; and
a traffic control mechanism coupled to the management module, wherein the traffic control mechanism causes each of the plurality of switch modules to adjust traffic to the server when the first condition is sensed in the server.

35. The system of claim 34, wherein the traffic control mechanism comprising means for transmitting a message to each of the plurality of switch modules.

36. The system of claim 35, wherein each of the switch modules executes a load balancing algorithm and each of the switch modules further comprising means for excluding the server from the load balancing algorithm in response to the message so that no new connections to the server are established.

37. The system of claim 36, wherein each of the switch modules further includes means for maintaining existing connections to the server.

38. The system of claim 34, wherein the traffic control mechanism further includes a timing means for setting a monitoring time.

39. The system of claim 38, wherein the first condition is a degrading environmental condition in the server caused by one of an excess temperature or voltage, an excessive number of memory errors, or PCI/PCIX parallel bus errors.

40. The system of claim 39, wherein the traffic control mechanism further comprising:
means for checking the degrading environmental condition in the server after the monitoring time expires; and
means for causing each switch module to readjust traffic to the server if the server recovers.

41. The system of claim 40, wherein the traffic control mechanism further comprises:
means for transmitting another message to each of the plurality of switch modules.

42. The system of claim 41, wherein each switch module further comprising:
means for including the server back into the load balancing algorithm in response to the another message so that the traffic to the server returns to its normal level.

43. The system of claim 40, wherein the traffic control mechanism further comprising means for resetting the timer if the server does not recover.

44. The system of claim 43, wherein the management module comprising:
means for transmitting an alarm to an administrator.
